(19) United States
(12) Patent Application Publication
(10) Pub. No.: US 2025/0218023 A1
(43) Pub. Date: Jul. 3, 2025

(54) Device and Method for Capturing Deliverables and/or Consumable Material

(71) Applicant: Würth International AG, Chur (CH)

(72) Inventors: Simon Koch, Dörzbach (DE); Adrien Marquette, Schwäbisch Hall (DE)

(21) Appl. No.: 18/852,554

(22) PCT Filed: Apr. 4, 2023
(86) PCT No.: PCT/EP2023/058869

§ 371 Date: Sep. 30, 2024

(30) Foreign Application Priority Data
Apr. 7, 2022 (DE) 10 2022 203 479.1

(51) Int. Cl. G06T 7/70; G06Q 10/0875; G06V 20/64

(52) U.S. Cl. CPC G06T 7/70; G06Q 10/0875; G06V 20/64

(57) ABSTRACT

A device for capturing deliverables and/or consumable material for manual activities in mobile use outside a workshop includes a capture device which is arranged in the region of a cargo space of a vehicle and is intended to capture tools and/or consumable material placed into the cargo space of the vehicle and/or removed from the cargo space of the vehicle. The device further includes a position-determining device in or on the vehicle for recording a spatial position of the vehicle or a route of the vehicle, an identification device in or on the vehicle for identifying occupants of the vehicle and a transfer device for transferring the acquired information to an evaluation unit.

### FIELD OF THE INVENTION

The invention relates to a device for capturing deliverables and/or consumable material for manual activities in mobile use outside a workshop. The invention also relates to an arrangement having a device according to the invention, to the use of the arrangement and to a method for capturing deliverables and/or consumable material for manual activities in mobile use outside a workshop.

### BACKGROUND

Manual activities can be performed in mobile use outside a workshop. For example, tradespeople drive their vehicle to a construction site. Tools and consumable material, for example screws, dowels, pipes, cable ducts and the like, are stored in the cargo space of the vehicle. Tools and consumable material are transported to the construction site by the vehicle. Once the work on the construction site has been completed, tools and the leftover consumer materials are placed back into the cargo space of the vehicle. In addition to the time that the tradesperson needed for the initial journey, for carrying out the work on the construction site and for the journey home, the required consumable material and optionally the period of use of special tools should also be billed. Moreover, the required consumable material has to be replenished promptly in order to have enough consumable material available again at the next construction site or on the next day.

### SUMMARY

The invention intends to improve a device for capturing deliverables and/or consumable material for manual activities in mobile use outside a workshop, an arrangement having a device according to the invention, the use of the arrangement according to the invention and a method for capturing deliverables and/or consumable material for manual activities in mobile use outside a workshop.

For this purpose, the invention provides a device having the features of claim 1, an arrangement having the features of claim 6, the use of the arrangement having the features of claim 7 and a method having the features of claim 8. Advantageous developments of the invention are apparent from the dependent claims.

In a device according to the invention for capturing deliverables and/or consumable material for manual activities in mobile use outside a workshop, provision is made for a capture device which is arranged in the region of a cargo space of a vehicle and is intended to capture tools and/or consumable material placed into the cargo space of the vehicle and/or removed from the cargo space of the vehicle. Provision is made for a position-determining device in or on the vehicle for recording a spatial position of the vehicle or a route of the vehicle. Provision is made for an identification device in or on the vehicle for identifying occupants of the vehicle and provision is made for a transfer device for transferring the acquired information to an evaluation unit.

By virtue of it being possible by means of the capture device to capture which tools and/or which consumable material and what amounts of consumable material are removed from the cargo space or are placed into the cargo space, it is possible to record already billable tool hours, if applicable, and the amount of the required consumable material in a very easy way. By means of the position-determining device in or on the vehicle for capturing a spatial position of the vehicle or a route of the vehicle, it is possible to record and, if applicable, bill not only the driving distance but also the duration of the work at the construction site, for which duration the vehicle is stationary, and/or the total use time of the vehicle. By means of an identification device in or on the vehicle for identifying occupants of the vehicle, it is possible to identify workers who went to the construction site via the vehicle. By means of the identification device, it is also possible to determine, for example, how long the occupants of the vehicle stayed in the vehicle and how long they actually worked on the construction site. A transfer device for transferring the acquired information to an evaluation unit then allows the billing itself or the preparation of the billing by means of the evaluation unit. The evaluation unit can, for example, also be used to reorder missing consumable material. The evaluation unit can, for example, be provided on a smartphone, a tablet or else on a workshop computer. When the vehicle returns to the workshop at the end of the working day or at any other time, the capture device, the position-determining device and the identification device can be read and the acquired information is transferred by means of the transfer device. On the basis of the acquired information, it is possible to compile a bill of the performed activities in a very easy way or it is also possible for only billing items to be formed and stored. A tools can be any kind of tool, for example a power tool, cable drums, ladders or the like.

In one development of the invention, the capture device has a readout unit for reading out RFID chips on the tool and/or on the consumable material.

If, for example, the tool, for example a large hammer drill or another special device or else just an electric screwdriver, is provided with an RFID chip, this RFID chip can thus be detected and read out by means of the capture device in a very easy way. The RFID chip normally contains a unique identifier, usually a number. In the capture device, this unique identifier can then be assigned information about which tool it relates to. Assigning the unique identifier to information can, however, also take place only in the evaluation unit, for example. Consumable material can also be provided with an RFID chip. In the case of larger or more expensive consumable materials, for example saw blades, drill bits and cutters, the RFID chip can be attached directly to the consumable material. In the case of less expensive consumable materials, for example screws, nails, pipe clamps or else varnish, the RFID chip can be arranged on packaging. The RFID chip can be read out either after a button on the capture device has been pressed or else automatically when the tool or the consumable material moves past the capture device.

In one development of the invention, the capture device has a reading unit for reading codes, in particular barcodes, QR codes and character codes.

The reading unit is, for example, a scanner, usually a laser scanner with which barcodes, QR codes and character codes are captured. The codes can be read, for example, by virtue of the tool or the consumable material being held in front of the reading unit.

In one development of the invention, the capture device has a camera and image evaluation software in order to detect tools and/or consumable material on the basis of an image.

For example, an image of the tool or of a tool box is taken and the capture device can then detect the tool box or the tool in the image or a sequence of numbers on the tool or on the tool box is detected. Consumable material, for example screws, can be detected by means of an image by virtue of the dimensions of the consumable material, for example the screw, which are ascertained by means of the image, being compared with dimensions stored in a database.

In one development of the invention, the position-determining device is in the form of a GPS unit.

By means of a GPS unit, a spatial position of the vehicle and a route of the vehicle as well as a journey time, start times and end times can be effortlessly recorded.

The identification device can, for example, be designed to detect an employee identity card of occupants of the vehicle.

The object on which the invention is based is also achieved by an arrangement having a device according to the invention, wherein a vehicle having a cargo space and an evaluation unit are provided.

The capture device can, for example, be arranged on a cargo space door such that tools and/or consumable material removed from the cargo space of the vehicle or placed into the cargo space have/has to be moved past the capture device automatically. The position-determining device, the identification device and the transfer device can also be arranged together with the capture device, for example in a common housing, on a cargo space door or in the region of a cargo space door of the vehicle. The evaluation unit is advantageously separated from the capture device and can, for example, be formed by a smartphone, a tablet or a workshop computer.

The object on which the invention is based is also achieved by the use of the arrangement according to the invention for compiling a bill of manual deliverables and/or of consumable material by means of the evaluation unit.

The invention makes compiling a bill substantially easier since journey times, working times, the working people, the tools used and the consumable material used have already been recorded and made available to the evaluation unit as a dataset.

The object on which the invention is based is also achieved by a method for capturing deliverables and/or consumable material for manual activities in mobile use outside a workshop, wherein provision is made for capturing tools and/or consumable material, placed into a cargo space of a vehicle and/or removed from the cargo space, by means of an electronic capture device, wherein provision is made for recording a spatial position and a route of the vehicle by means of an electronic position-determining device, in particular the traveled route, the stopping points and the time spent on the route or at the stopping points, respectively, and wherein provision is made for identifying occupants of the vehicle by means of an electronic identification device and transferring the acquired information to an evaluation unit.

In one development of the invention, provision is made for compiling a bill of manual deliverables and/or of consumable material based on the transferred information.

In one development of the invention, provision is made for reordering or reserving consumable material based on the transferred information, in particular in a workshop storeroom of the tradesperson or in a distribution warehouse.

Consumable material can be reordered from a supplier or else be reserved in a workshop storeroom of the tradesperson.

### BRIEF DESCRIPTION OF THE DRAWINGS

Further features and advantages of the invention are apparent from the following description of a preferred embodiment of the invention in connection with the drawings. In the drawings:

FIG. 1 shows a schematic illustration of an arrangement having a device for capturing deliverables and/or consumable material, having a vehicle having a cargo space and having an evaluation unit, and

FIG. 2 shows the capture device and the evaluation unit of the arrangement of FIG. 1 in an enlarged illustration.

### DETAILED DESCRIPTION

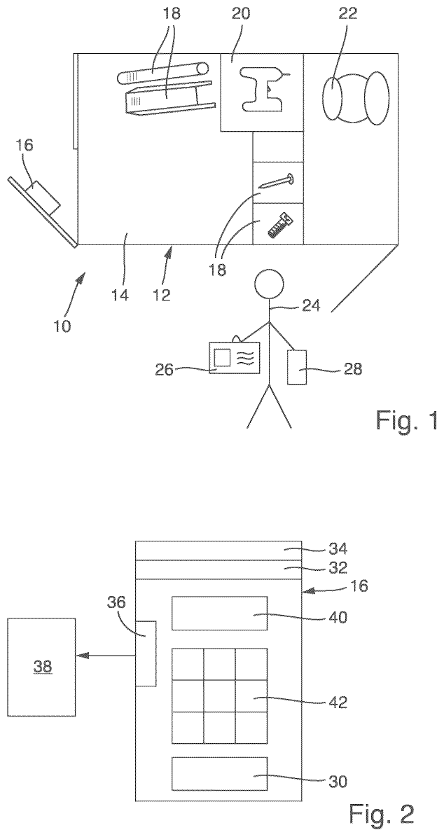

FIG. 1 schematically shows an arrangement 10 according to the invention having a vehicle 12 which has a cargo space 14. A device 16 for capturing deliverables and/or consumable material is arranged on a rear door of the vehicle. Consumable material 18 in the form of nails and screws as well as in the form of pipes and cable ducts is arranged within the cargo space 14. Tools 20 are furthermore arranged in the cargo space 14, in the illustrated case an electric screwdriver.

A first worker 22 sits in the vehicle 12. A second worker 24 stands outside the vehicle. The second worker 24 holds their employee identity card 26 in their hand and an evaluation unit in the form of a smartphone 28.

The device 16 has a capture device for capturing tools 20 and/or consumable material 18 placed into the cargo space 14 and/or removed from the cargo space of the vehicle. By means of this capture device, it is thus possible, for example, to determine the equipment in the vehicle. If the cargo space 14 is empty at the start and all of the tools 20 and consumable material 18 placed into the cargo space 14 are captured, the inventory in the cargo space of the vehicle can be compiled by means of the capture device and be transferred, for example, to the smartphone 28. The worker 24 can then, for example, check whether all of the required consumable material 18 and all of the required tools 20 are in the cargo space 14 before the start of the journey.

If the manual activities have been performed and the vehicle 12 returns to the workshop, the worker 24 can again determine using their evaluation unit, the smartphone 28, how much consumable material 18 and which tools 20 are still in the cargo space 14. If applicable, the worker 24 can then reorder consumable material 18 by means of the evaluation unit, that is to say their smartphone 28, or else load the tools 20 that are required on the next day or for the next manual activity.

A very significant point, however, is that by means of the device 16 and in particular the capture device in the device 16 it is possible to determine which tools 20 have been used during the performance of the manual activities and for how long, and how much consumable material 18 was required. This information can be transferred to an evaluation unit. The evaluation unit can again be the smartphone 28 or else, for example, a workshop computer, using which a bill is then compiled or using which billing items are compiled and stored.

The device 16 also has a device for determining the position of the vehicle 12, for example a GPS unit. The device 16 can thus record what driving distance the vehicle 12 has traveled, which places, in particular construction sites, have been stopped at and how long the vehicle was stationary and which route the vehicle has traveled. These data can also be transferred to the evaluation unit, for example the smartphone 28, by means of the transfer device in the device 16 and a bill or billing items can then be compiled by means of the evaluation unit.

The device 16 also has an identification device for identifying occupants of the vehicle 12. The employee identity cards 26 of the two workers 22, 24 are used for this purpose, for example. For example, the two workers 22, 24 can identify themselves at the identification device in the device 16 before the start of the journey. The device 16 then records how long the workers 22, 24 have driven in the vehicle and/or how long the workers 22, 24 have been on the construction site. These data can then be transferred to an evaluation unit, for example the smartphone 28, by means of the transfer device in the device 16, and a bill can then be compiled, or billing items can be compiled and stored, by means of the evaluation unit.

The device 16 also has, as was explained, a transfer device. This transfer device can, for example, operate wirelessly by means of mobile radio or else by means of a wireless network, for example WLAN. It is also possible to only query the data of the device 16 when the evaluation unit is brought close to the device 16. Transmission of the data by means of the transfer device can then take place, for example, also by means of the Bluetooth standard.

FIG. 2 shows the device 16 in a schematic, enlarged illustration. The device 16 has, as was explained, a capture device 30 for capturing tools and/or consumable material placed into the cargo space of the vehicle and/or removed from the cargo space of the vehicle. For this purpose, the capture device 30 can, for example, have a reading device in the form of a scanner or a reading device for reading out RFID chips. Consumable material 18 and tools 20 are then held just in front of the capture device 30 in order to read out the RFID chip on the tool 20 or on the consumable material or in order to read a code on the tool or on the consumable material.

The device 16 is furthermore provided with a position-determining device for recording a spatial position of the vehicle and a route of the vehicle. This device is indicated only schematically in FIG. 2 by the reference sign 32.

The device 16 is furthermore provided with an identification device for identifying occupants of the vehicle or generally workers 22, 24. This identification device can likewise be realized by means of the device 30. For example, an employee identity card 26 contains an RFID chip which is then read out by the device 30 in order to supply the identification device 34 with the unique identifier from the RFID chip, from which the worker 22, 24 can then be identified.

Finally, the device 16 is provided with a transfer device 36 by means of which the information acquired from the device 16 can be transferred to an evaluation unit 38.

The device 16 yet further has a display 40 and an interface device in the form of a keypad 42.

1. A device, for capturing deliverables and consumable material for manual activities in mobile use outside a workshop, comprises:
a capture device which is arranged in the region of a cargo space of a vehicle and is intended to capture tools and consumable material (18) placed into the cargo space of the vehicle and/or removed from the cargo space of the vehicle,
a position-determining device in or on the vehicle for recording a spatial position of the vehicle or a route of the vehicle,
an identification device in or on the vehicle for identifying occupants of the vehicle, and
a transfer device for transferring the acquired information to an evaluation unit,
wherein the evaluation unit is designed to reorder or reserve consumable material based on the transferred information.

2. The device as claimed in claim 1, wherein the capture device has a readout unit for reading out RFID chips on tools and/or on consumable material.

3. The device as claimed in claim 1, wherein the capture device has a reading unit for reading codes, in particular barcodes, QR codes and character codes on tools and/or on consumable material.

4. The device as claimed in claim 1, wherein the capture device has a camera and image evaluation software in order to detect tools and/or consumable material on the basis of an image.

5. The device as claimed claim 1, wherein the position-determining device is in the form of a GPS unit.

6. An arrangement comprising:
a device as claimed in claim 1,
a vehicle having a cargo space and
an evaluation unit.

7. The use of the arrangement from claim 6 for compiling a bill of manual deliverables and/or consumable material by means of the evaluation unit.

8. A method for capturing deliverables and consumable material for manual activities in mobile use outside a workshop, comprising:
capturing tools and consumable material, placed into a cargo space of a vehicle and/or removed from the cargo space, by means of an electronic capture device,
recording a spatial position and a route of the vehicle by means of an electronic position-determining device, in particular the traveled route, the stopping points and the time spent on the route or at the stopping points, respectively,
identifying occupants of the vehicle by means of an electronic identification device and
transferring the acquired information to an evaluation unit,
characterized by recording or reserving consumable material based on the transferred information.

9. The method as claimed in claim 8, further comprising compiling a bill of manual deliverables and/or of consumable material based on the transferred information.

10. (canceled)
